(19) United States
(12) Patent Application Publication
(10) Pub. No.: US 2020/0024813 A1
(43) Pub. Date: Jan. 23, 2020

(54) WHITE PAVEMENT MARKING

(71) Applicant: 3M INNOVATIVE PROPERTIES COMPANY, St. Paul, MN (US)

(72) Inventors: Thomas P. HEDBLOM, Eagan, MN (US); Susannah C. CLEAR, Hastings, MN (US)

(21) Appl. No.: 16/495,779

(22) PCT Filed: Mar. 14, 2018
(86) PCT No.: PCT/IB2018/051707

§ 371 Date: Sep. 19, 2019

Related U.S. Application Data
(60) Provisional application No. 62/473,862, filed on Mar. 20, 2017.

(51) Int. Cl. E01F 9/524; E01F 9/512; E01F 9/518; G01N 21/84; G01S 17/88; G01N 21/47

(52) U.S. Cl. CPC E01F 9/524; E01F 9/512; G01N 21/4738; G01N 21/84; G01S 17/88; E01F 9/518

(57) ABSTRACT

White pavement marking (100) being readily apparent to both the human driver and sensors on a vehicle in both the daytime and night time. The pavement marking comprises a nonporous binder layer (110) comprising a titanium dioxide-coated synthetic mica pearlescent pigment and retroreflective elements (120) distributed on at least a portion of the nonporous binder layer.

### TECHNICAL FIELD

The present disclosure relates to a white pavement marking.

### BACKGROUND

Pavement or road markings (e.g., paints, tapes, and individually mounted articles) guide and direct motorists and pedestrians traveling along roadways and paths. Pavement or road markings can be used on, for example, roads, highways, parking lots, and recreational trails. Typically, pavement markings form stripes, bars, and markings for the delineation of lanes, crosswalks, parking spaces, symbols, legends, and the like.

Paint was a preferred pavement marking for many years. Retroreflective liquid pavement markings typically include retroreflective elements. Retroreflective liquid pavement marking offer significant advantages over paint, such as increased visibility, retroreflectance, improved durability, and temporary and/or removable marking options. Such retroreflective elements are described in, for example, U.S. Pat. Nos. 5,750,191; 5,774,265; 5,942,280; 7,513,941; 8,591,044; 8,591,045; and U.S. Patent Publication Nos. 2005/0100709 and 2005/0158461, all of which are incorporated herein in their entirety. Commercially available retroreflective elements include, for example, All Weather Elements, Reflective Elements Series 50, made by 3M Company of St. Paul, Minn. Typically, a retroreflective element includes a core adjacent to numerous glass or glass ceramic beads that are adhered to the outermost surface of core by a binder.

Retroreflective tapes incorporate retroreflective elements durably adhered to a flexible substrate, which in turn is adhered to the roadway to delineate features on the surface such as lanes. Such retroreflective tapes are described in, for example, U.S. Pat. No. 5,777,791, which is incorporated herein in its entirety. Commercially available pavement marking tapes include, for example, 3M™ Stamark™ High Performance Tape 3801 ES and 3M™ Stamark™ All Weather Tape 380AW.

To be effective, pavement markings need to be apparent in both daytime and nighttime driving conditions. At nighttime when the roadway in front of the vehicle is illuminated by primarily by headlamps, the retroreflectivity of the marking is critically important to the visibility of the marking. In the daytime, however, the illumination is primarily from the sun or scattered diffuse light from the sky, not the headlamps. In the daytime, the difference in luminance of the marking relative to the surrounding roadway substrate under those daytime illumination conditions is critical to detection of the marking and differentiation from the substrate. In conventional automobiles, visible detection of the pavement marking by the human driver is necessary. In addition, sensors on vehicles can be made to detect the absence or presence of a pavement marking and its location relative to a vehicle and to the trajectory of a vehicle. These data serve as inputs to advanced driver assistance systems such as lane departure warning systems and lane keeping systems, as well as autonomous driving systems or autopilot functions. Therefore, detection of the pavement marking by the sensors on vehicles is advantageous to enable the sensor to provide information to the vehicle.

### SUMMARY

To be effective, pavement markings need to be visually apparent in both daytime and nighttime driving conditions. The disclosed white pavement marking is readily apparent to both the human driver and sensors on the vehicle in both the daytime and night time. In one embodiment, the pavement marking comprises a nonporous binder layer comprising a titanium dioxide-coated synthetic mica pearlescent pigment and retroreflective elements distributed on at least a portion of the nonporous binder layer.

### BRIEF DESCRIPTION OF DRAWINGS

FIG. 1 shows a side-sectional view of one embodiment of the pavement marking;

FIG. 2 shows a side-sectional view of a second embodiment of the pavement marking.

While the above-identified drawings and figures set forth embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of this invention. The figures may not be drawn to scale.

### DETAILED DESCRIPTION

In one aspect, the present inventors sought to improve daytime and nighttime appearance and conspicuity of pavement markings. In another aspect, the present inventors sought to increase detectability of white pavement markings by machine vision systems in autonomous vehicles. In yet another aspect, the present inventors sought to increase contrast of white pavement markings and the surface to which they are applied (e.g., asphalt, concrete).

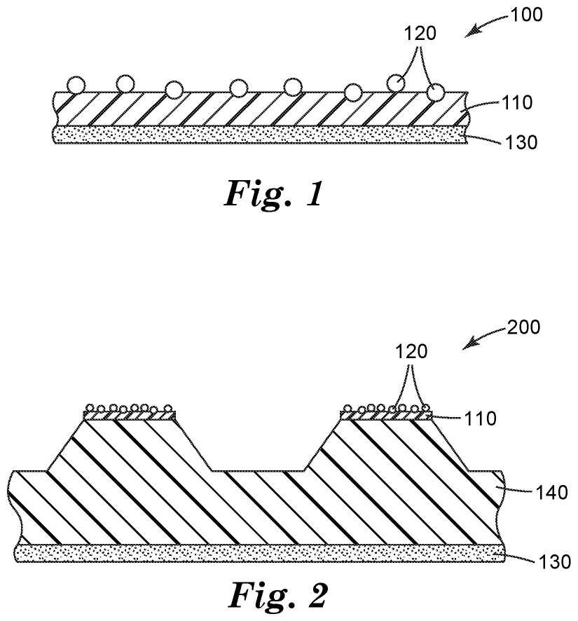

The disclosed white pavement marking is readily apparent to both the human driver and sensors on the vehicle in both daytime and nighttime. FIG. 1 shows a cross sectional view of one embodiment of a pavement marking 100. The pavement marking 100 comprises a nonporous binder layer 110 comprising a synthetic titanium dioxide-coated mica pearlescent pigment and retroreflective elements 120 distributed on a surface of the nonporous binder layer 110. In one embodiment, the synthetic titanium dioxide-coated mica pearlescent pigment is distributed throughout the nonporous binder layer 110.

FIG. 2 shows a cross sectional view of a second embodiment of a pavement marking 200 with a construction having peaks and valleys, and will be referred to as an embossed structure. The pavement marking 200 comprises a nonporous binder layer 110 comprising a synthetic titanium dioxide-coated mica pearlescent pigment and retroreflective elements 120 distributed on a surface of the nonporous binder layer 110 and an additional backing layer 140.

The nonporous binder layer 110 typically comprises a polymeric material. Any number of know polymeric materials may be used for the nonporous binder layer(s) 110 of the pavement marking 100. Illustrative examples of suitable polymeric materials include thermoset materials and thermoplastic materials. Suitable polymeric material includes, but is not limited to, urethanes, epoxies, alkyds, acrylics, acid olefin copolymers such as ethylene/methacrylic acid and its ionomers, ethylene/acrylic acid, polyvinyl chloride/polyvinyl acetate copolymers, etc.

The nonporous binder layer 110 may be a reactive system capable of substantial crosslinking, including: two-part polyurethane, a polyurea, a glycidyl-substituted acrylic, or epoxy. The nonporous binder layer 100 also may be an extrudable polymer, including a substituted polyolefin or polyolefin copolymer, polyurethane, acrylic, or acrylic copolymer. The nonporous binder layer 110 also may be a film formed from a film-forming latex or emulsion, including a polyurethane latex, acrylic latex or a styrenic elastomer emulsion.

In one embodiment, the pavement marking 100 is a liquid applied to the substrate (i.e., the roadway) with the retroreflective elements 120 applied to the exposed surface of nonporous binder 110 of the pavement marking 100. In one embodiment, the pavement marking 100 is a tape. Typically, when the pavement marking 100 is a tape, an additional backing 140 will be included. The additional backing layer 140 is typically positioned adjacent the nonporous binder 110 opposite from the surface containing the retroreflective elements 120.

In one embodiment, such as shown in FIG. 2, the additional backing layer 140 is an embossed rubber backing, such as disclosed in U.S. Patent Publication No. 2014/0011911, the disclosure of which is herein incorporated by reference. In one embodiment, the material of the nonporous binder layer 110 itself secures the retroreflective elements 120 to a thermoplastic backing, such as disclosed in PCT Publication WO 2016/205443, the disclosure of which is herein incorporated by reference.

In one embodiment, the nonporous binder comprising the titanium dioxide-coated synthetic mica pearlescent pigment is coated onto the top surfaces of the embossed features on an embossed rubber pavement marking substrate such as described in U.S. Pat. No. 4,988,541, the disclosure of which is herein incorporated by reference. In one such embossed embodiment, these coated surfaces have a cumulative area percentage of 29% of the pavement marking, and the embossed features have a square face 6.5 mm in length, are 1.9 mm above the base, are arranged in rows and columns, and are spaced apart at a distance of 5.4 mm. This embodiment has a Qd, the luminance coefficient under diffuse illumination as defined by ASTM E2303 (discussed further below), of at least 225 mcd·m−2·1x−1. In one embodiment, the disclosed white pavement marking has a Qd of at least 240 mcd·m−2·1x−1.

In one embodiment, the pavement marking 100 further comprises an adhesive 130 for securing the pavement marking 100 to a substrate, like a roadway or sidewalk. The adhesive may be a hot melt adhesive or may be a pressure sensitive adhesive. An optional release lines maybe included to protect the exposed surface of the adhesive before the pavement marking 100 is applied to a surface.

In one embodiment, the nonporous binder layer 110 itself is used to secure the pavement marking 100 to a substrate, like a roadway or sidewalk. For example, the nonporous binder layer 110 may be heated up to partially melt the material to the nonporous binder layer 110 to secure the pavement marking 100 to a substrate.

The synthetic mica pigments are coated platelets of fluorphlogopite mica and are created in synthetic processes instead of being mined. Because this pigment is a platelet shape, the pigment additionally acts as a reflective mirror to reflect the light entering in through the retroreflective element. Natural mica, phlogopite (KMg₃(AlSi₃O₁₀)(OH)₂), contains hydroxyl moieties, while synthetic fluorphlogopite (KMg₃(AlSi₃O₁₀)F₂), does not, and those groups are fully substituted with fluoro moieties. Synthetic mica is colorless, and highly transmissive to ultraviolet, visible and infrared wavelengths. Natural mica, by comparison, contains varying levels of metal contaminants because it is a natural mined product, and these contaminants absorb light and impart color to the natural mica.

Examples of commercially available titanium dioxide-coated synthetic mica pearlescent pigments are Iriodin® 6103 Icy White, Iriodin® 6111 Icy White Pristine KU26, Iriodin® 6123 Icy White Satin, Iriodin® 6153 Icy White Flash, and Iriodin® 6163 Icy White Shimmer from EMD Performance Materials and Glacier™ Exterior Frost White S1303D, Glacier™ Exterior Silk White EH 2112 (51303V), Glacier™ Exterior Crystal White EH 2130 (SP1303I) from BASF.

The titanium dioxide-coated synthetic mica pearlescent pigment imparts whiteness to the pavement marking 100 to make the pavement marking 100 readily apparent to both human vision and machine vision. Therefore, the titanium dioxide-coated synthetic mica pearlescent pigment is very pure and free of contaminants, which increases the whiteness of the pigment. In one embodiment, the titanium dioxide-coated mica pearlescent pigment contains less than 50 ppm of the following metals that can impart color, including antimony, mercury, cadmium, lead, chromium, nickel, copper and zinc and contains less than 0.25% wt. of any other metal compounds that impart color.

The pavement marking 100 further comprises retroreflective elements 120. Such retroreflective elements 120 are commonly used to make the pavement marking 100 more visually apparent in nighttime conditions. The retroreflective elements 120 are designed to return light to the vicinity of the originating light source. Selection of the retroreflective element 120 can also make the pavement marking 100 more apparent in nighttime and wet conditions. Any commonly used retroreflective elements 120 can be used with the pavement marking 100. In one embodiment, the retroreflective elements 120 are glass or ceramic beads. In one embodiment, the retroreflective elements 120 are glass or ceramic beads with a refractive index of 1.75-2.45. In one embodiment, the retroreflective elements 120 are glass or ceramic beads with a 1.9 refractive index prepared as described in U.S. Pat. No. 6,245,700, the disclose of which is herein incorporated by reference. In one embodiment, the retroreflective elements 120 are glass or ceramic beads with a 2.45 refractive index prepared as described in U.S. Pat. No. 7,513,941, the disclose of which is herein incorporated by reference. In one embodiment, the retroreflective elements 120 are a combination of 50:50 (by weight) of the 1.9 index retroreflective elements and 2.45 index retroreflective elements. Elements disclosed in, for example, U.S. Pat. Nos. 6,245,700; 7,513,941; 8,591,044; 8,591,045, the disclosure of which are herein incorporated by reference, disclose various constructions of retroreflective elements 120 suitable for use with the pavement marking 100.

The retroreflective elements 120 are secured to the nonporous binder layer 110. In one embodiment, the material of the nonporous binder layer 110 itself secures the retroreflective elements 120 to an additional backing material 140.

One measure of the luminance, or brightness, of a surface is Y, as defined in the CIE xyY color space, which is derived from the CIE 1931 XYZ color space created by the International Commission on Illumination (CIE). Values for x and y describe the chromaticity of the surface. A perfectly black surface that absorbs all light will have a value of Y of zero, and a perfectly white surface that reflects all light from a uniform spectrum source will have a value of Y of one hundred. Real surfaces fall between these limits. To improve differentiation of a pavement marking from surrounding darker substrate or contrast markings, it is desirable that the pavement marking have a higher Y value.

The pavement marking 100 with nonporous binder layer 110 comprising the titanium dioxide-coated mica pearlescent pigment and retroreflective elements has a Y, a measure of luminance, of at least 56. In one embodiment, the disclosed white pavement marking has a Y of at least 60. In one embodiment, the disclosed white pavement marking has a Y of at least 64.

Another relevant measure of the daytime “brightness” of the surface is the luminance factor for diffuse illumination, Qd, which is defined by ASTM E2302-03A and IS EN 1436 European Standard for Road Markings. The surface is illuminated with diffuse light, and then the reflected light is measured at an observation angle of 2.29 degrees to simulate a 30 meter viewing distance from a vehicle. To improve differentiation of a pavement marking from surrounding darker substrate or contrast markings, it is desirable that the pavement marking have a higher Qd value.

The pavement marking 100 with nonporous binder layer 110 comprising the titanium dioxide-coated synthetic mica pearlescent pigment and retroreflective elements has a Qd, a measure of luminance, of at least 225 mcd·m−2·1x−1. In one embodiment, the disclosed white pavement marking has a Qd of at least 240 mcd·m−2·1x−1.

The disclosed white pavement marking is both retroreflective and achieves a higher CAP-Y value and Qd value via incorporation of titanium dioxide-coated synthetic mica specular pigments into a nonporous binder layer in which microspherical retroreflective elements are partially embedded.

The disclosed pavement marking is highly retroreflective and has higher luminance in ambient daylight illumination to improve contrast making the pavement marking more visually apparent to a human driver and to a digital image.

In one embodiment, a reader on a vehicle is used to identify the pavement marking. Such readers might be a camera, a LiDAR (light imaging, detection and ranging) system, or both. In one embodiment, the reader identifies the pavement marking by comparison of the contrast of the white pavement marking against the substrate. In one embodiment, reader identifies the pavement marking by a measure of luminance of the white pavement marking.

Although specific embodiments have been shown and described herein, it is understood that these embodiments are merely illustrative of the many possible specific arrangements that can be devised in application of the principles of the invention. Numerous and varied other arrangements can be devised in accordance with these principles by those of skill in the art without departing from the spirit and scope of the invention. The scope of the present invention should not be limited to the structures described in this application, but only by the structures described by the language of the claims and the equivalents of those structures.

### EXAMPLES

MATERIALS

| Trade Designation | Description | Manufacturer |
|---|---|---|
| CAPA 3031 | Equivalent Weight: 300 | Perstorp, Malmo, |
| | | Sweden |
| Methyl ethyl ketone | | |
| Acetone | | |
| Afflair 9119 pigment | Natural mica pearlescent pigment | EMD Performance |
| | | Materials, |
| | | Philadelphia, PA |
| DESMODUR N100 | Solvent-free, aliphatic polyisocyanate | Covestro, |
| | resin based on hexamethylene | Pittsburgh, |
| | diisocyanate (HDI), with an equivalent | |
| | weight of 191. | PA |
| GLACIER ™ | White pigment comprising synthetic | BASF, |
| EXTERIOR SILK | mica and titanium dioxide. Particle | Florham Park, |
| WHITE EH 2112 | size ranges from about 4 to about 22 | NJ |
| (S1303V) | micrometers (D50: 11 micrometers) | |
| GLACIER ™ | White pigment comprising synthetic | BASF |
| EXTERIOR FROST | mica and titanium dioxide. Particle | Florham Park, |
| WHITE S1303D | size ranges from about 8 to about 48 | NJ |
| | micrometers (D50: 19 micrometers) | |
| 3M ALL WEATHER | A 50:50 blend of 1.9 refractive index | |
| MICROSPHERE | elements prepared as described in | |
| ELEMENT | U.S. Pat. No. 6,245,700 and a 2.4 | |
| | refractive index elements as prepared | |
| | as described in U.S. Pat. No. 7,513,941 | |
| 1.9 Refractive Index | 1.9 refractive index elements prepared | |
| Element | as described in U.S. Pat. No. 6,245,700 | |
| 2.4 Refractive Index | 2.4 refractive index elements as prepared | |
| Element | as described in U.S. Pat. No. 7,513,941 | |
| WHITE FLAT | A flat rubber substrate of the composition | |
| BACKING | described in U.S. Pat. No. 4,490,432 | |
| WHITE EMBOSSED | An embossed rubber pavement marking | |
| BACKING | substrate prepared from a composition | |
| | described in U.S. Pat. Application US | |
| | Patent App. 2014/0011911 with the | |
| | modifications described in Embossed | |
| | Pavement Marking below, and embossed | |
| | as described in U.S. Pat. No. | |
| | 4,988,541 A. | |

Embossed Pavement Marking

Embossed features on an embossed rubber pavement marking substrate were prepared as described in U.S. Patent Application 2014/0011911 A1 with following rubber composition:

50 PARTS—“NIPOL 1022”: copolymer of butadiene and acrylonitrile with 33% acrylonitrile and density of 0.98 g/cm.sup.3, obtained from Zeon Chemicals, Louisville, Ky.

50 PARTS—“NIPOL 1072”: copolymer of butadiene and acrylonitrile with 27% acrylonitrile and density of 0.98 g/cm.sup.3, obtained from Zeon Chemicals.

8.8 PARTS—“POLYESTER FIBERS 3.0 DPF X ¼”: polyester fibers having a density of 1.38 g/cm.sup.3, obtained from Minifibers Inc., Johnson City, Tenn.

29.2 PARTS—“NUCREL 699”: copolymer of ethylene and methacrylic acid, nominally 11% methacrylic acid, with a density of 0.94 g/cm.sup.3, obtained from DuPont, Wilmington, Del.

20.9 PARTS—“CHLOREZ 700-S”: chlorinated paraffin with a 71.5% chlorine content and density of 1.60 g/cm.sup.3, obtained from Dover Chemical, Dover, Ohio.

0.9 PARTS—“EMERSOL 132 NF STEARIC ACID”: stearic acid having a density of 0.88 g/cm.sup.3, obtained from Emery Oleochemicals, Cincinnati, Ohio.

1.8 PARTS—“LOWINOX TBM6”: anti oxidant with a density of 1.09 g/cm.sup.3, obtained from Chemtura Corporation, Middlebury, Conn.

0.4 PARTS—“VANSTAY SC”: liquid phosphate (trisooctyl phosphate (TIOP)) having a density of 0.89 g/cm.sup.3, obtained from R. T. Vanderbilt Company, Norwalk, Conn.

5 PARTS—“PAROIL 140”: liquid chlorinated paraffin having a density of 1.18 g/cm.sup.3, obtained from Dover Chemical.

0.4 PARTS—“Ultramarine Blue-5016”: blue pigment having a density of 2.30 g/cm.sup.3, obtained from Mineral and Pigment Solutions Inc., South Plainfield, N.J.

19.8 PARTS—“ATOMITE”: calcium carbonate having a density of 2.71 g/cm.sup.3, obtained from Imerys USA Inc, Roswell, Ga.

85.3 PARTS—“KRONOS TITANIUM DIOXIDE”: titanium dioxide (TiO.sub.2) with a density of 3.90 g/cm.sup.3, obtained from Kronos Inc., Houston, Tex.

17.6 PARTS—“Hi-Sil 233”: amorphous silicon dioxide having a density of 1.95 g/cm.sup.3, obtained from PPG Industries, Pittsburgh, Pa.

82.7 PARTS—“TALC MIST SUP FROST”: talc with a density of 2.75 g/cm.sup.3, obtained from Luzenac America Inc., Greenwood Village, Colo.

246 PARTS—“GLASS BEADS 70-170 MESH, 1.5 Index”: glass beads with a density of 2.50 g/cm.sup.3, obtained from Potters Industries Inc., Valley Forge, Pa.

After mixing, the rubber composition was embossed as described in U.S. Pat. No. 4,988,541 A1. These coated surfaces have a cumulative area percentage of 29% of the pavement marking, and the embossed features have a square face 6.5 mm in length, are 1.9 mm above the base, are arranged in rows and columns, and are spaced apart at a distance of 5.4 mm. A combination of 50:50 1.9 index retroreflective elements prepared as described in U.S. Pat. No. 6,245,700, and 2.4 index retroreflective elements prepared as described in U.S. Pat. No. 7,513,941, are partially embedded in the nonporous binder layer 110.

Test Methods

Luminance, Y, as defined in the CIE xyY color space: Y was measured for flat samples according to ASTM D6628-03 on a Hunterlab Labscan 2 colorimeter (available from Hunter Associates Laboratory, Reston, Va.) with a 45°:0° illuminating and viewing geometry.

Luminance Coefficient under Diffuse Illumination, Qd: Qd was measured for embossed samples according to ASTM E2302-03a and the IS EN 1436 European Standard for Road Markings on a LTL-XL reflectometer made by Delta from (Venlighedsvej 4, 2970 Horsholm, Denmark) at an observation angle of 2.29 degrees to simulate a 30 m viewing distance.

### Examples 1-6 and Comparative Examples A-C

Pavement markings of Examples 1-6 and Comparative Examples A-C were prepared as follows: polyol was diluted to 68% solids with a 50:50 mixture of acetone and methyl ethyl ketone, and white pigment was pre-mixed with the diluted polyol at a pigment loading content of 28% based on the final total solids weight of the pigment/polyol/polyisocyanate mixture. Polyisocyanate was subsequently added to the polyol/pigment premix at a 37:63 polyisocyanate: polyol premix ratio and homogenized.

For measurements of the luminance, Y, on flat, uniformly coated substrates, the polyurethane coating was coated on a white flat backing of the composition described in U.S. Pat. No. 4,490,432 at a thickness of 15 mils. Elements were poured over the wet coating, and the excess elements were removed. Samples were cured overnight at room temperature.

For measurements of the luminance, Y, and the luminance coefficient under diffuse illumination, Qd, on embossed substrates, the polyurethane coating was coated at 15 mils on the tops of raised embossed features on white embossed backing, which is an embossed rubber pavement marking substrate prepared from a composition described in U.S. Patent Application US2014/0011911 A1 with the previously disclosed formulation and embossed as described in U.S. Pat. No. 4,988,541 and as described above. Elements were poured over the wet coating, and the excess elements were removed. Samples were cured overnight at room temperature.

TABLE 1
Composition of Examples 1-6 and Comparative Examples A-C

| | | | | Reflective | |
|---|---|---|---|---|---|
| Examples | Polyol | Pigment | Isocyanate | Elements | Substrate |
| Example 1 | CAPA 3031 | BASF | DESMODUR | 3M ALL | WHITE |
| | (68% | GLACIER | N100 | WEATHER | EMBOSSED |
| | SOLIDS) | SILK | | MICROSPHERE | BACKING |
| | | WHITE | | ELEMENTS | |
| | | 9S130V | | | |
| Example 2 | CAPA 3031 | BASF | DESMODUR | 1.9 Refractive | WHITE |
| | (68% | GLACIER | N100 | Index | FLAT |
| | SOLIDS) | SILK | | ELEMENTS | BACKING |
| | | WHITE | | | |
| | | 9S130V | | | |
| Example 3 | CAPA 3031 | BASF | DESMODUR | 2.4 Refractive | WHITE |
| | (68% | GLACIER | N100 | Index Elements | FLAT |
| | SOLIDS) | SILK | | | BACKING |
| | | WHITE | | | |
| | | 9S130V | | | |
| Example 4 | CAPA 3031 | BASF | DESMODUR | 3M ALL | WHITE |
| | (68% | GLACIER | N100 | WEATHER | EMBOSSED |
| | SOLIDS) | FROST | | MICROSPHERE | BACKING |
| | | 9S130D | | ELEMENTS | |
| Example 5 | CAPA 3031 | BASF | DESMODUR | 1.9 Refractive | WHITE |
| | (68% | GLACIER | N100 | Index | FLAT |
| | SOLIDS) | FROST | | ELEMENTS | BACKING |
| | | 9S130D | | | |
| Example 6 | CAPA 3031 | BASF | DESMODUR | 2.4 Refractive | WHITE |
| | (68% | GLACIER | N100 | Index Elements | FLAT |
| | SOLIDS) | FROST | | | BACKING |
| | | 9S130D | | | |
| Comparative | CAPA 3031 | Afflair 9119 | DESMODUR | 3M ALL | WHITE |
| Example A | (68% | pigment | N100 | WEATHER | EMBOSSED |
| | SOLIDS) | | | MICROSPHERE | BACKING |
| | | | | ELEMENTS | |
| Comparative | CAPA 3031 | Afflair 9119 | DESMODUR | 1.9 Refractive | WHITE |
| Example B | (68% | pigment | N100 | Index | FLAT |
| | SOLIDS) | | | ELEMENTS | BACKING |
| Comparative | CAPA 3031 | Afflair 9119 | DESMODUR | 2.4 Refractive | WHITE |
| Example C | (68% | pigment | N100 | Index Elements | FLAT |
| | SOLIDS) | | | | BACKING |

Samples of Examples 1-6 and Comparative Examples A-C were inspected and measured for luminance Y and in eight locations for luminance factor Qd using the test methods described above. Respective test results are reported in Table 2, below.

TABLE 2

| | Luminance, | Qd |
|---|---|---|
| Examples | Y | (mcd · m − 2 · 1 × −1) |
| Example 1 | 67.4 +/− 1.3 | 249.8 +/− 6.8 |
| Example 2 | 60.0 | — |
| Example 3 | 64.8 | — |
| Example 4 | 68.8 +/− 1.4 | 250.2 +/− 4.4 |
| Example 5 | 61.4 | — |
| Example 6 | 63.0 | — |
| Comparative | 64.5 +/− 1.0 | 221.6 +/− 7.1 |
| Example A | | |
| Comparative | 50.8 | — |
| Example B | | |
| Comparative | 55.4 | — |
| Example C | | |

Those having skill in the art will appreciate that many changes may be made to the details of the above-described embodiments and implementations without departing from the underlying principles thereof. The scope of the present disclosure should, therefore, be determined only by the following claims.

1. A pavement marking comprising:
a nonporous binder layer comprising a titanium dioxide-coated synthetic mica pearlescent pigment;
a plurality of retroreflective elements distributed on at least a portion of the nonporous binder layer.

2. The pavement marking of claim 1, wherein the nonporous binder layer is a polyurethane.

3. The pavement marking of claim 1, wherein the titanium dioxide-coated synthetic mica pearlescent pigment is dispersed throughout the nonporous binder layer.

4. The pavement marking of claim 1, wherein the synthetic mica pearlescent pigment is essentially free of contaminants.

5. The pavement marking of claim 1, wherein the pavement marking has a Y of at least 56.

6. (canceled)

7. The pavement marking of claim 1, wherein the pavement marking has a Qd of at least 225 mcd·m−2·1x−1.

8. The pavement marking of claim 1, wherein the pavement marking has a Qd of at least 240 mcd·m−2·1x−1.

9. The pavement marking of claim 1, wherein the retroreflective elements are at least partially embedded into the nonporous binder layer.

10. The pavement marking of claim 1, wherein the retroreflective elements is a glass or ceramic bead.

11. The pavement marking of claim 1, wherein the retroreflective elements comprise a microspherical element with a refractive index between 1.75-2.45.

12. The pavement marking of claim 1, further comprising an adhesive.

13. The pavement marking of claim 1, wherein the retroreflective elements are on a first major surface of the nonporous binder layer and an adhesive is on a second major surface of the nonporous binder layer.

14. The pavement marking of claim 1, wherein the nonporous binder layer is a liquid pavement marking.

15. The pavement marking of claim 1, wherein the nonporous binder layer is a tape.

16. The pavement marking of claim 1, further comprising an additional backing that is an embossed backing.

17. The pavement marking of claim 1, further comprising an additional backing that is an embossed rubber backing.

18. The pavement marking of claim 1, further comprising an additional backing that is a thermoplastic backing.

19. The pavement marking of claim 1, wherein the retroreflective elements are on a first major surface of the nonporous binder layer, a backing is on the second major surface of the nonporous binder layer, and an adhesive is on the opposite surface of the backing.

20. A system for identifying a pavement marking comprising:
a reader;
a white pavement marking comprising a nonporous binder layer comprising a titanium dioxide-coated synthetic mica pearlescent pigment;
retroreflective elements distributed on at least a portion of the nonporous binder layer;
wherein the reader identifies the pavement marking by comparison of the contrast of the white pavement marking against the substrate.

21. The system of claim 20, wherein the reader identifies the pavement marking by a measure of luminance of the white pavement marking.
